(19) United States
(12) Patent Application Publication
(10) Pub. No.: US 2006/0098434 A1
(43) Pub. Date: May 11, 2006

(54) Direct type backlight module

(75) Inventors: Ming-Dah Liu, Chu-Nan (TW); Hao-Jan Kuo, Chu-Nan (TW)

Correspondence Address: BIRCH STEWART KOLASCH & BIRCH, PO BOX 747, FALLS CHURCH, VA, 22040-0747, US

(73) Assignee: Coretronic Corporation

(21) Appl. No.: 11/134,300

(22) Filed: May 23, 2005

(30) Foreign Application Priority Data
Nov. 10, 2004 (TW) 93134199

(51) Int. Cl. F21V 13/04

(52) U.S. Cl. 362/246; 362/245; 362/330

(57) ABSTRACT

The present invention relates to a direct type backlight module providing a planar backlight source, wherein it adopts several light-emitting elements, and the light emitted from the light-emitting elements directly illuminates a diffuser, or is reflected by a reflector, and then the reflected light illuminates the diffuser. Via light-compensating elements installed between any two neighboring light-emitting elements, the present invention solves the brightness defects occurring in the portions between any two neighboring light-emitting elements and further increases the brightness and uniformity of a planar backlight source.

### FIELD OF THE INVENTION

The present invention relates to a direct type backlight module, particularly to a direct type backlight module, which has a promoted brightness and uniformity via providing additional light-compensating elements to improve the brightness defects occurring in the regions between any two neighboring light-emitting elements.

### BACKGROUND OF THE INVENTION

Generally speaking, a backlight module refers to an assembly of parts that provides a backlight source for the product. The typical application thereof is the backlight source of a flat panel display, such as a liquid crystal display LCD. The light-emitting elements currently used by a backlight module include: electron luminescence (EL), cold cathode fluorescent lamp (CCFL), and light-emitting diode (LED). According to the position for the backlight source, a backlight module can be divided into the direct type and the edge-side type.

The light-emitting elements currently used by the direct type backlight module include: multiple light-emitting diodes arranged into an array, and multiple cold cathode fluorescent lamps arranged in parallel.

Please refer to FIG. 1. A conventional direct type backlight module 10 is composed of a reflector 12, a plurality of CCFLs 14 and a diffuser 16. The light emitted from the CCFL 14 illuminates the diffuser 16 directly, or is reflected by the reflector 12, and by the fog effect of the diffuser 16, a planar backlight source having a uniform brightness is provided.

In the conventional direct type backlight module 10, the brightness of the regions most close to the CCFLs 14 is higher than that of the regions far from the CCFLs 14, which induces brightness defects (i.e. a shadow phenomenon) at the regions between any two neighboring CCFLs 14 and further influences the brightness uniformity of the planar light source of the conventional direct type backlight module 10.

As shown in FIGS. 2 and 3, a conventional technology utilizes a modified surface of the reflector 14 to improve the brightness defect, such as a zigzag surface 12a as shown in FIG. 2, or a wave-like surface 12b as shown in FIG. 3. Although improving the brightness defects occurring in the regions between any two neighboring CCFLs 14, those methods will increase the difficulty of compacting the backlight module.

Another conventional technology for improving the brightness defect is to install light-shielding elements 18 above the CCFLs 14, as shown in FIG. 4, or to print light-shielding patterns 19 on some portions of the bottom surface of the diffuser 16, wherein those portions are ones most close to the CCFLs 14, as shown in FIG. 5, in order to reduce the orthogonal light energy of the CCFLs 14. Those methods can improve the total performance of uniformity; however, the total brightness of the backlight module decreases as the orthogonal light energy is shielded.

Besides, if a viewer observes the direct type backlight module 10 shown in FIG. 5 from a non-orthogonal viewing angle (i.e. angle θ with respect to the normal), the non-uniformity of the brightness will become even more serious as the relative position of the CCFLs 14 and the light-shielding pattern 19 shifts, as shown in FIG. 6. The light-shielding element 18 as shown in FIG. 4 has the non-uniform problem when a viewer observes the direct type backlight module 10 form a non-orthogonal viewing angle. Further, the printed light-shielding pattern 19 also has a problem of the color deterioration resulting from an ink aging.

### SUMMARY OF THE INVENTION

One objective of the present invention is to provide a direct type backlight module for improving the insufficient brightness occurring between any two neighboring light-emitting elements and further to increase the total performance of the brightness and uniformity.

To achieve the objective mentioned above, in the present invention, light-compensating elements are installed at the regions between any two neighboring light-emitting elements to improve the brightness defects occurring in the regions between any two neighboring light-emitting elements so as to increase the brightness and uniformity of a planar backlight source.

Also to achieve the objectives mentioned above, the present invention utilizes a structure of total-reflection prisms to realize the aforementioned light-compensating element. In one preferred embodiment of the present invention, the light-compensating elements are disposed at the positions that are above the regions between any two neighboring CCFLs and intervene between the diffuser and the CCFLs. In another preferred embodiment of the present invention, the structures of total-reflection prisms are formed directly onto some regions of the bottom of the diffuser, wherein those regions correspond to the positions intervening between any two neighboring CCFLs. The light emitted from two lateral sides of the CCFL is guided to some regions of the diffuser, wherein those regions correspond to the positions intervening between any two neighboring CCFLs, in order to compensate the brightness in those regions and increase the total performance of the brightness and uniformity.

The preferred embodiments and detailed technical contents of the present invention will be stated below in co-operation with the drawings.

### BRIEF DESCRIPTION OF THE DRAWINGS

FIG. 1 is a structural diagram of a conventional direct type backlight module.

FIG. 2˜FIG. 5 are structural diagrams of other conventional direct type backlight modules.

FIG. 6 is a schematic diagram showing that the conventional direct type backlight module shown in FIG. 5 is observed from the view of a different angle.

FIG. 7 is a structural diagram of the direct type backlight module according to the present invention.

FIG. 8 is a schematic diagram showing the optical path of the direct type backlight module according to the present invention.

FIG. 9 is a diagram of a preferred embodiment of the light-compensating element according to the present invention.

FIG. 10 is a diagram of a preferred embodiment of the arc-type light-compensating element according to the present invention.

FIG. 11A˜FIG. 11C are diagrams of preferred embodiments of the geometric designs of the light-compensating element's contour according to the present invention.

FIG. 12 is a diagram of a preferred embodiment that the present invention's light-compensating elements are disposed onto a transparent planar plate.

FIG. 13 is a diagram of the prismatic plates is integrated with the diffuser.

FIG. 14 is a schematic diagram of the brightness values measured at several points in a conventional direct type backlight module.

FIG. 15 is a schematic diagram of the brightness values measured at several points in the direct type backlight module according to the present invention.

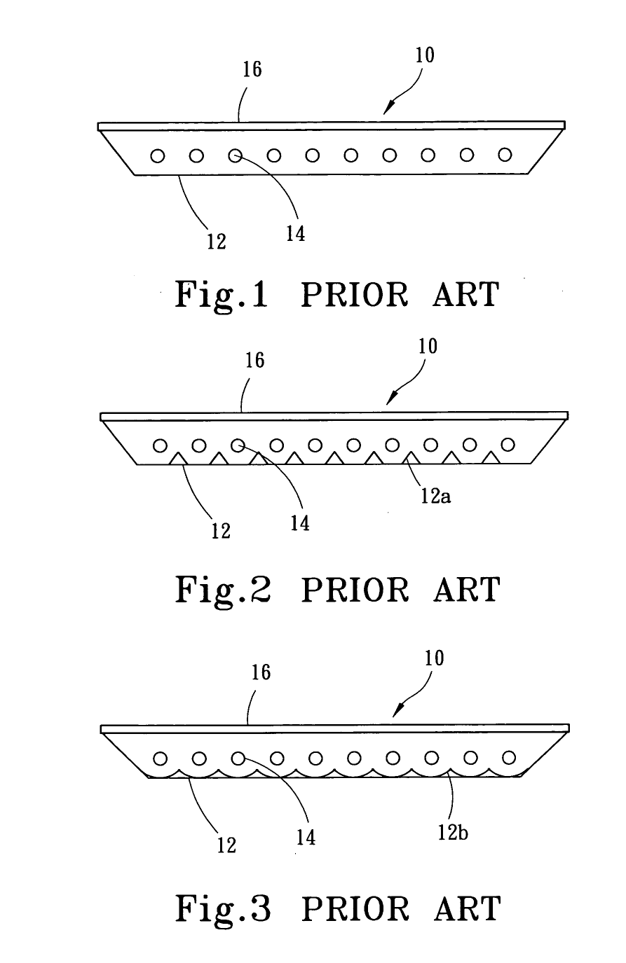

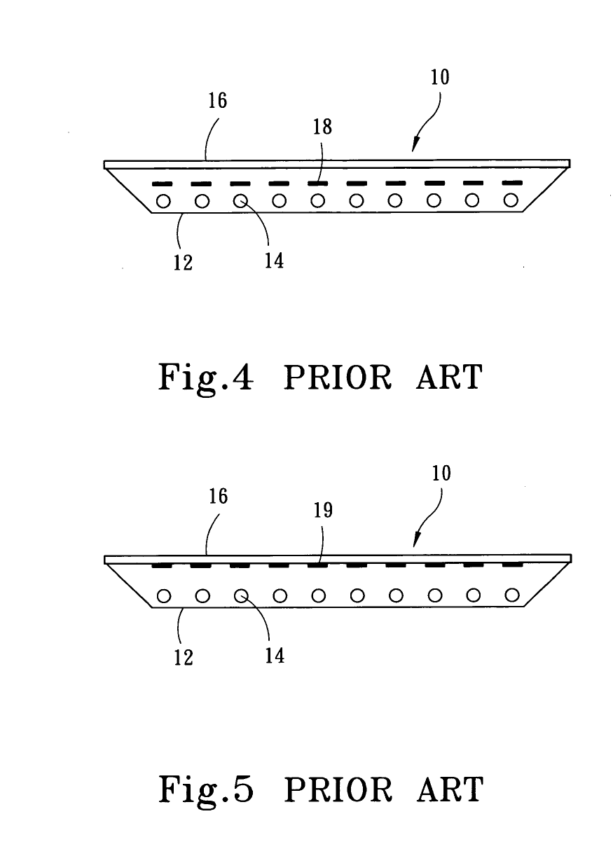

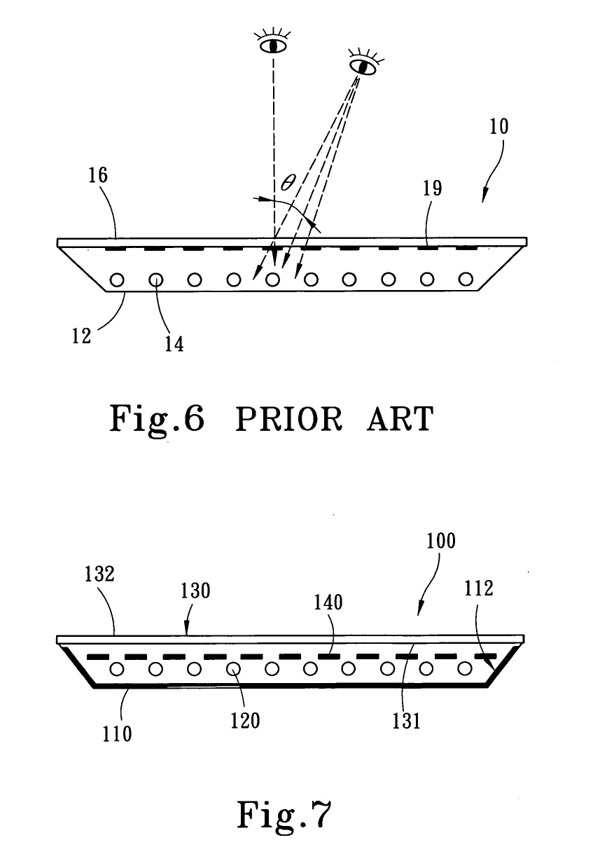

### DETAILED DESCRIPTION OF THE PREFERRED EMBODIMENTS

FIG. 7 shows a structural diagram of the structure of a first preferred embodiment, wherein the direct type backlight module 100 that utilizes a CCFL 120 as a light source. The direct type backlight module 100 of the present invention comprises a reflector 110, a plurality of CCFLs, a diffuser 130 and a plurality of light-compensating elements 140.

A plurality of CCFLs 120 is disposed inside the reflector 110 and arranged in parallel with each other in an appropriate spacing. The diffuser 130 is placed over the reflector 110 and positioned above the CCFLs 120. The diffuser 130 is an optical plate, which provides the light with a fogging effect, has an incident face 131 fronting the CCFLs and an exit face 132 opposite to the incident face 131, and the light emitted from the exit face 132 of the diffuser 130 has a uniform brightness. The light-compensating elements 140 are disposed at regions corresponding to those positions between any two neighboring CCFLs 120 and interpose between the diffuser 130 and the CCFLs 120.

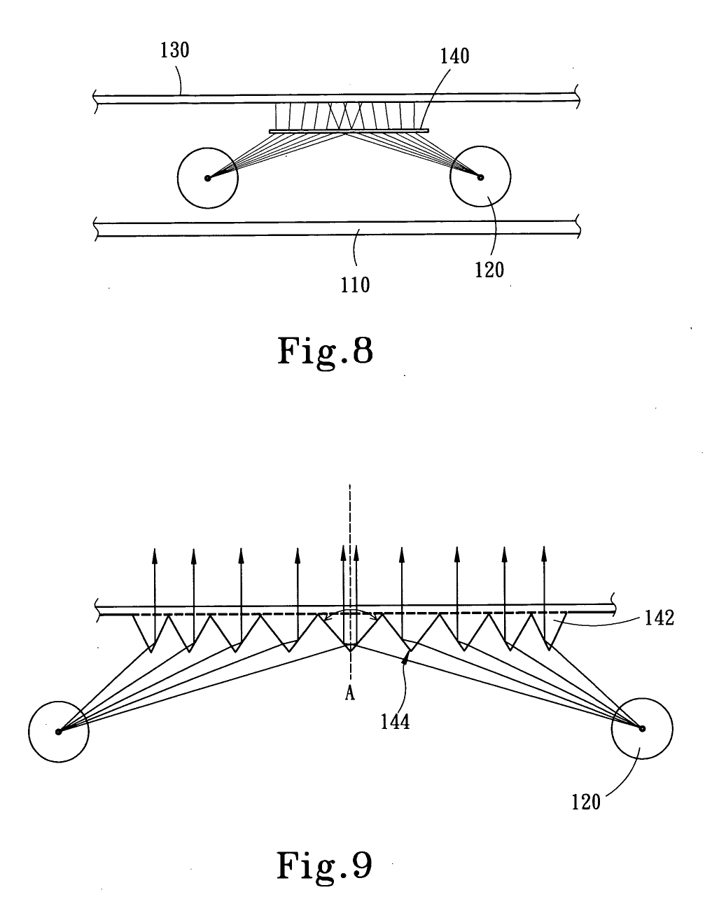

The reflector 110 is used to reflect a part of the light emitted from the CCFLs 120 to the diffuser 130. The reflector 110 is a metallic material, or is disposed with a reflective material 112 on the surface of the reflector 110. Referring to FIG. 8, the light-compensating elements 140 are used to condense and guide the light emitted from any two neighboring CCFLs 120 toward some regions of the diffuser 130, wherein those regions correspond to the positions between any two neighboring CCFLs 120, in order to improve the defects of insufficient brightness occurring between any two neighboring CCFLs 120 and further to increase the total brightness and uniformity.

Please refer to FIG. 9, the light-compensating element 140 is realized via a prismatic plate, and an optical total-reflection prism plate would be a better choice thereof; it can be made of a transparent material, such as a glass, or an acrylic, etc. The prismatic plate is of a planar shape, which is disposed above the region between two neighboring CCFLs 120 and interposes between the diffuser 130 and the CCFLs 120 via supporting elements or means (not shown in the drawings).

The bottom of the prismatic plate, i.e. the incident face, possesses a plurality of prisms 142 arranged side by side. After the incidence into the prism 142, the light emitted from the CCFL 120 will be condensed and guided onto a region of the diffuser 130 according to principle of refraction and total reflection, wherein the region corresponds to the position between two neighboring CCFLs 120. Further, the vertex angle 144 of the prism 142 can be modified according the incident angle of the light emitted from the CCFL 120. For example, taking the central line A of the prismatic plate as the reference line, the vertex angle 144 of the prism 142 close to the central line A is designed to be different from that of the prism 142 far away from the central line A. In this embodiment, the vertex angle 144 of the prism 142 close to the central line A is designed to be larger than that of the prism 142 far away from the central line A, which helps increase the light-condensing effect.

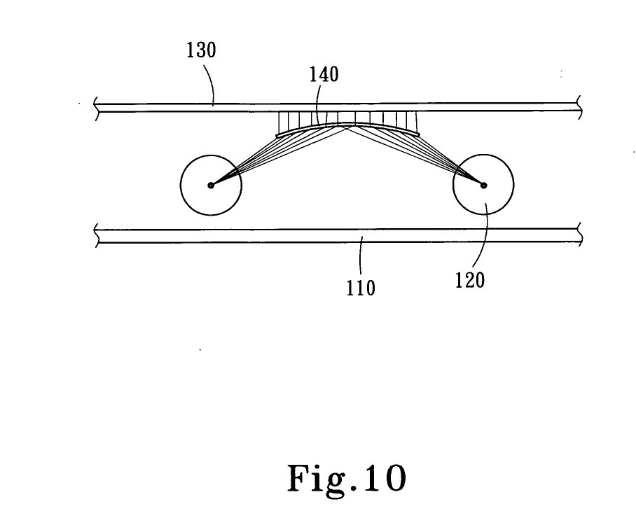

Please refer to FIG. 10. The present invention modifies the shape of the light-compensating element 140 to achieve the aforementioned objective. The light-compensating element 140 is a prismatic plate and an arc shape. The incident face of the prismatic plate faces the curvature center of the arc in order to enable the light to project upward onto the diffuser 130 for increasing the light-condensing effect. Further, the top portion of the prismatic plate can be treated with a gradient fogging procedure, such as a sandblast or a coating, for reducing the dispersion of the prismatic plate or the image discontinuity occurring in the region corresponding to the edge of the prismatic plate.

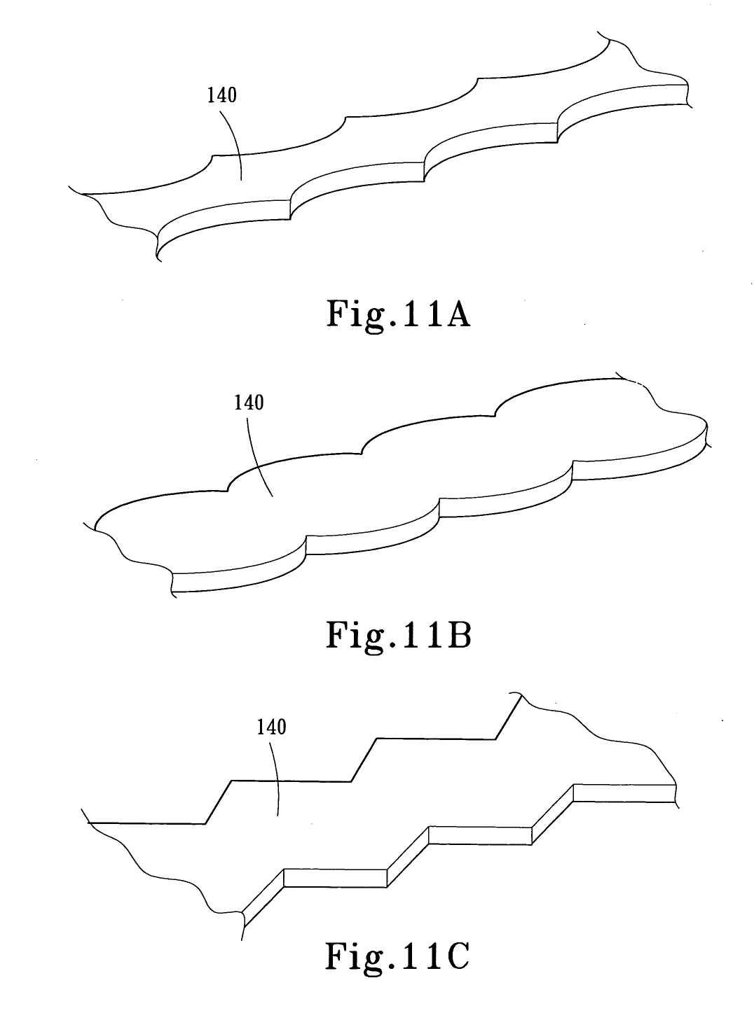

Please refer to the FIGS. 11A, 11B and 11C, the geometric-shape design of the contour of the light-compensating element 140 enables the brightness generated by the light, which passes through the light-compensating element 140 and projects onto the diffuser 130 without a distinct border. The geometric shapes are continuous wave-like shape (shown in FIG. 11A), continuous arc shape (shown in FIG. 11B), and continuous zigzag shape (shown in FIG. 11C), all of which can improve the image discontinuity corresponding to the edge of the prismatic plate.

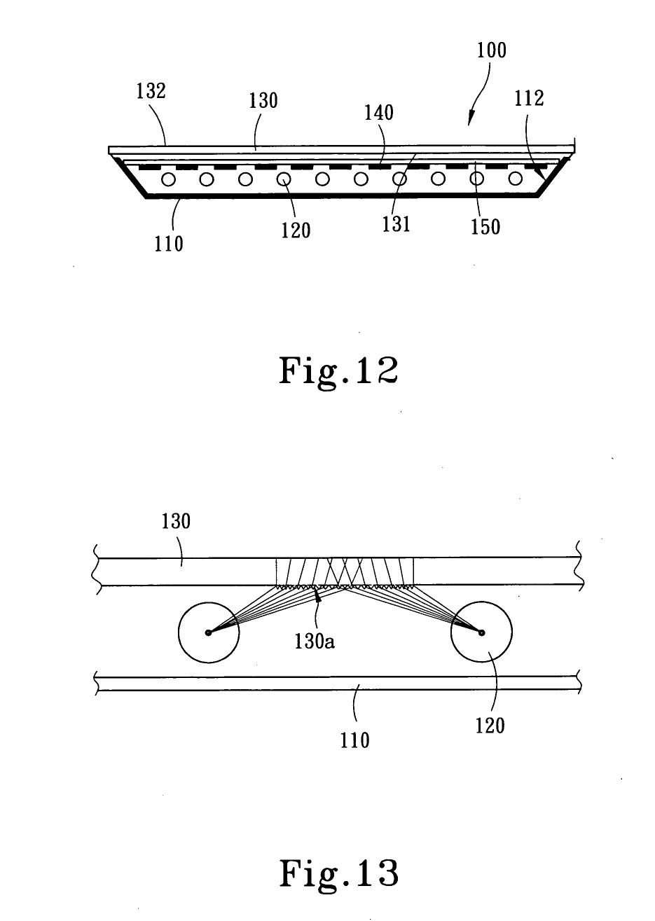

FIG. 12 shows an embodiment that the light-compensating elements 140 of the present invention are disposed onto a transparent plate 150. The transparent plate 150 is installed between the CCFLs 120 and the diffuser 130, and a plurality of the light-compensating elements 140 are attached above the transparent plate 150. It is to be appreciated by a person skilled in the art that if permitted by the design of the optical path, the light-compensating elements 140 can be directly disposed onto the diffuser 130 rather than onto the transparent plate 150, and it has the same convenience of fixing.

Referring to FIG. 13, the diffuser 130 and the prismatic plates are integrated into a unit. The direct type backlight module 100 of the present invention is not limited to utilize the independent dedicated light-compensating elements 140, and total-reflection prism's structures 130a can also be adopted and directly formed in some regions of the diffuser 130, wherein those regions correspond to the positions between any two neighboring CCFLs 120. The total-reflection prism's structure 130a is equivalent to the prisms 142 of the prismatic plate in the aforementioned embodiment, and via the total-reflection prism's structures 130a, the light is guided to some regions of the diffuser 130, wherein those regions correspond to the positions between any two neighboring CCFLs 120, in order to compensate the brightness defects occurring between any two neighboring CCFLs 120.

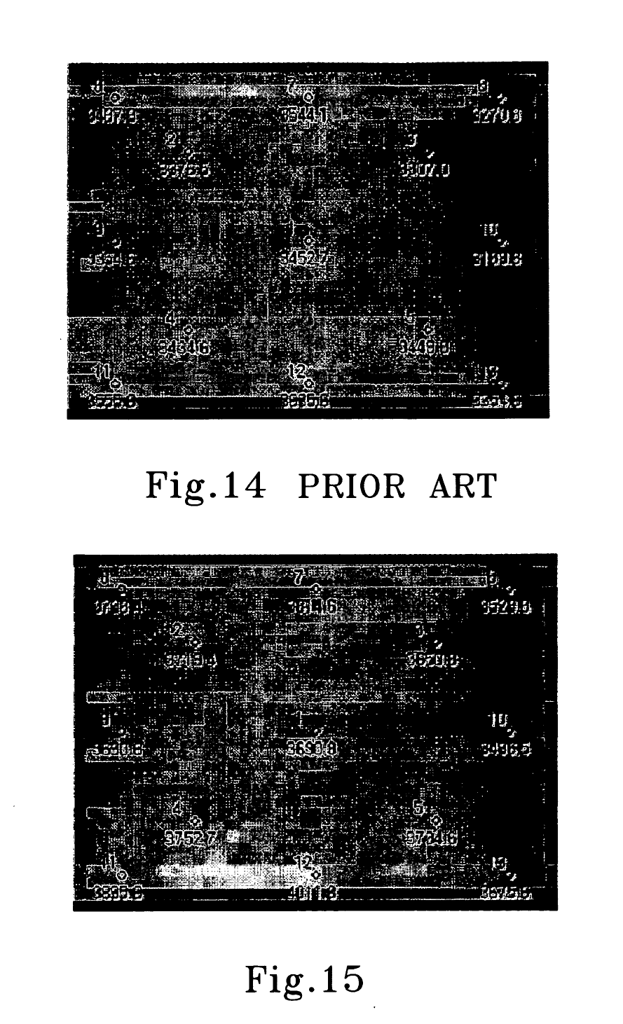

FIG. 14 is a schematic diagram of the brightness values measured at several points in a conventional direct type backlight module. FIG. 15 is a schematic diagram of the brightness values measured at several points in the direct type backlight module of the present invention. Comparing FIG. 15 with FIG. 14, it is obvious that each of the values measured at point 1 to point 13 in the backlight module of the present invention is larger than the corresponding one measured at the corresponding point in the conventional backlight module; for example, the brightness value at point 1 in the conventional one is 3452.7; however, the brightness value at point 1 in the present invention is 3690.8. According to that, it is further confirmed that via installing the light-compensating elements, the direct type backlight module of the present invention not only can improve the non-uniformity of the planar light source occurring in the conventional one but also can increase the total performance of brightness with about 10% increase thereof.

In the present invention, via disposing the light-compensating elements in the regions corresponding to the positions between any two neighboring CCFLs, the light emitted from the lateral sides of the CCFLs is guided onto the diffuser's regions corresponding to the positions between any two neighboring CCFLs, so that the brightness between two neighboring CCFLs is compensated, and the light energy efficiency is also raised. Further, the total performance of the brightness and the uniformity is increased. It is to be appreciated by the persons skilled in the art that in the present invention, the light-compensating element is not limited to the prismatic plate and any other light-compensating element, which can guide the light emitted from the lateral sides of the CCFLs toward the region above the position between two neighboring CCFLs, is to be included within the scope of the present invention. Besides, the prismatic plates, or the like, can be integrated with the diffuser to directly form the structures of the total-reflection prisms on those diffuser's regions corresponding to the positions between any two neighboring CCFLs, which can also compensate the brightness between two CCFLs, raise the light energy efficiency and increase the total performance of the brightness and the uniformity.

In conclusion, the present invention, wherein the light-compensating elements are disposed in the regions between any two neighboring CCFLs to guide the light emitted from the light-emitting elements toward the regions above any two neighboring CCFLs, has the following advantages:
1. Increasing the total brightness and the light-utilization efficiency of the light-emitting element;
2. Improving the uniformity no matter whether the backlight module observed from the orthogonal or the lateral view;
3. Being beneficial for the compacting of the backlight module as it is unnecessary to change the shape of the reflector.

Furthermore, having described the invention in connection with certain specific embodiments thereof, it is to be understood that further modifications may now suggest themselves to those skilled in the art, it is intended to cover all such modifications as fall within the scope of the appended claims.

What is claimed is:

1. A direct type backlight module for providing a planar backlight source, comprising:
a plurality of light-emitting elements for providing light sources;
a diffuser having an incident face fronting said light-emitting elements; and an exit face opposite to said incident face; and
a plurality of light-compensating elements disposed between said light-emitting elements and said diffuser;
wherein said light-compensating element is a prismatic plate with a plurality of prisms on the surface fronting said light-emitting elements, and the light emitted from neighboring said light-emitting elements is refracted into said prisms and totally reflected inside said prisms and then guided onto a diffuser's region corresponding to the position between two neighboring said light-emitting elements.

2. The direct type backlight module according to claim 1, wherein said light-emitting element is a cold cathode fluorescent lamp (CCFL).

3. The direct type backlight module according to claim 1, wherein said light-emitting element is a light-emitting diode (LED).

4. The direct type backlight module according to claim 1, wherein said light-compensating elements are positioned above the regions between any two neighboring said light-emitting elements.

5. The direct type backlight module according to claim 1, wherein taking the central line of said prismatic plate as the reference line, the vertex angle of said prism close to said central line is different from that of said prism far away from said central line.

6. The direct type backlight module according to claim 1, wherein said prismatic plate is of a planar shape.

7. The direct type backlight module according to claim 1, wherein one surface of said prismatic plate, which fronts said diffuser, is processed with a gradient fogging treatment.

8. The direct type backlight module according to claim 1, wherein said prismatic plates and said diffuser are integrated into a unit.

9. The direct type backlight module according to claim 1, wherein said prismatic plate is an arc shape.

10. The direct type backlight module according to claim 1, which further comprises a transparent planar plate installed between said light-emitting elements and said diffuser, wherein said light-compensating elements are disposed onto the surface of said transparent planar plate.

11. The direct type backlight module according to claim 1, wherein the edge of said prismatic plate is a zigzag shape.

12. The direct type backlight module according to claim 1, wherein the edge of said prismatic plate is a continuous arc-like shape.

13. The direct type backlight module according to claim 1, wherein the edge of said prismatic plate is a continuous wave-like shape.

14. The direct type backlight module according to claim 1, wherein the material of said prismatic plate is a glass.

15. The direct type backlight module according to claim 1, wherein the material of said prismatic plate is an acrylic.

16. The direct type backlight module according to claim 1, which further comprises a reflector, wherein said light-emitting elements interpose between said reflector and said diffuser, and via said reflector, a portion of the light emitted from said light-emitting elements is reflected to said diffuser.
